(19) United States
(12) Patent Application Publication
(10) Pub. No.: US 2025/0282967 A1
(43) Pub. Date: Sep. 11, 2025

(54) RESIN FORMULATION CONTAINING DYE AND USE THEREOF AS A HIGH PURITY MARKER PEN

(71) Applicant: Illinois Tool Works Inc., Glenview, IL (US)

(72) Inventor: Scott Andrew Frank, Glenview, IL (US)

(73) Assignee: Illinois Tool Works Inc., Glenview, IL (US)

(21) Appl. No.: 19/062,243

(22) Filed: Feb. 25, 2025

Related U.S. Application Data
(60) Provisional application No. 63/563,555, filed on Mar. 11, 2024.

(51) Int. Cl. C09D 11/17; C08K 3/34; C08K 5/18; C09D 11/18

(52) U.S. Cl. CPC C09D 11/17; C08K 3/34; C08K 5/18; C09D 11/18

(57) ABSTRACT

A marker pen is provided with a barrel, a nose cone connected to the barrel and terminating in a tip, the barrel and nose cone collectively defining a volume that holds a marker resin formulation contained within the volume, the resin formulation includes a polymer, a solvent in which the polymer is dissolved or dispersed, and an organic dye of Solvent Blue 5; with the proviso that the formulation has a chloride content of less than 100 ppm, a total metal content of less than 300 ppm, and a sulfur content of less than 250 ppm or alternatively, a thickener is present and retains the purity at a viscosity of at least 10,000 centipoise. A process of marking a surface includes applying a continuous bead of the formulation to a surface.

### RELATED APPLICATIONS

This application claims priority benefit of U.S. Provisional Application Ser. No. 63/563,555, filed Mar. 11, 2024; the contents of which are hereby incorporated by reference.

### FIELD OF THE INVENTION

The present invention in general relates to resin formulation and in particular, to resin formulation that dries under standard temperature and pressure to form a coating amenable for use as a marker pen with superior purity compared to the prior art.

### BACKGROUND OF THE INVENTION

Marker pens are routinely colored with resort to inorganic pigments that are referred to as high purity inks for marking on stainless steel or any surface where degradation, contamination, or other adverse effects are a concern. The formulation of high purity inks requires meeting all of the usual requirements for ink as to properties such as viscosity, color shade, color density, adhesion, dry time, opacity, and safety. Additionally, limits are placed on constituent components. These limits might be defined formally through various specifications, such as those detailed in D50TF8_S7—GE Aircraft Engines—Temporary Marking Materials for Engine Parts.

The D50TF8_S7 requirements are concerned with three particular categories of chemical ions: halogens, low melting point metals, and assorted components that include sulfur and nitrates. In practice, for most marker color formulations, achieving both the color density and the low halogen content is difficult. Halogens routinely enter marker formulations a chloride impurities to dyes or pigments. While these standards can be achieved for several colors with a low viscosity surface marker formulations, thickener contaminants have precluded the production of high purity, high viscosity surface marker formulations.

The color blue presents a special challenge as the pigments most commonly used are copper complexes; and copper is one of the disallowed metals in many marker formulation specifications. Resort to blue dyes has met with limited success as many common blue dyes are also inclusive of copper complexes. Those blue dyes exclusive of copper tend to have poor color strength, are not widely commercially available, suffer from chloride impurities, or a combination of these limitations.

Thus, there exists a need for application markers for application of high purity surface marker formulations that dry to a hard film with limited extraneous components. There also exists a need for high viscosity, high viscosity surface marker formulations.

### SUMMARY OF THE INVENTION

A marker pen is provided with a barrel, a nose cone connected to the barrel and terminating in a tip, the barrel and nose cone collectively defining a volume that holds a marker formulation contained within the volume with a nose cone connected to the barrel and terminating in a tip, the barrel and nose cone collectively defining a volume that holds a marker resin formulation contained within the volume, the formulation includes a resin, a solvent in which the resin is dissolved or dispersed, and an organic dye of Solvent Blue 5; with the proviso that the formulation has a chloride content of less than 100 ppm, a total metal content of less than 300 ppm, and a sulfur content of less than 250 ppm or alternatively, a thickener is present and retains the purity at a viscosity of at least 10,000 centipoise.

A process of marking a surface includes applying a continuous bead of the formulation to a surface. The solvent evaporates to a state of dry-to-touch in a time of between 1 and 60 seconds to mark the surface. The formulation is readily applied from a pen to achieve a controlled bead width. The drying of the formulation by solvent evaporation achieves a drying to full hardness in 24 hours as measured under standard temperature and pressure and 0% relative humidity.

### BRIEF DESCRIPTION OF THE DRAWINGS

FIG. 1 is a side view of a marker with a medium acrylic nib in accordance with embodiments of the invention; and

FIGS. 2A-2E are a series of detailed views of a medium nib, fine nib, steel tip, steel fine tip, and pressure bulb, respectively for use with embodiments of the marker of FIG. 1.

### DETAILED DESCRIPTION OF THE INVENTION

The present invention has utility as a high purity blue surface marker formulation and a marker pen containing such a high purity formulation that is able to function in environments such as medical marking and nuclear power plants. In some inventive embodiments, an inventive formulation is dry to the touch in 60 seconds or less, as measured at standard temperature and pressure (STP). An inventive formulation also provides a spectrum of colors with the exclusion of extraneous ions and metals that are not needed for the coloration or drying of the marker pen formulation at a viscosity of greater than 10,000 centipoise through inclusion of a purified thickener.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

As used herein, polymer molecular weight is weight average molecular weight (Mw), unless otherwise specified.

As used herein, maximal linear extent refers to the longest orthogonal axis of a particle. By way of example a spherical particle has identical maximal linear extent in all three orthogonal axes (X-Y-Z) and represents the particle diameter. While some particles, such as titanium dioxide are generally spherical, montmorillonite or kaolin based thickeners have a lamellar form, a sphericity of approximately 0.28 and a pronounced anisotropy. It is appreciated that the marker pen formulations used herein must contain pigment particle sizes sufficient to be conveyed homogenously through a porous marker tip nib or a steel roller tip.

As used herein, a high purity ink refers to an ink with a formulation with a total halogen content of less than 250 ppm, a total metal content of less than 300 ppm, a total of nitrates and nitrites of less than 850 ppm, and a sulfur content of less than 250 ppm, or a combination of some or all of the above limitations. Metals excluded by the 200 ppm limit are lead, antimony, arsenic, bismuth, cadmium, gallium, indium, mercury, silver, tin, and zinc. Halogens included in the 250 ppm limit illustratively include bromide, chloride, fluoride, and iodide.

Resin operative in a marker pen formulation of the present invention include those detailed in U.S. Pat. No. 7,820,755 based on a polyurethane (urethane alkyd polymer) resin, polyester resins that are linear aromatic polyesters, and co-polymers thereof, containing at least 40 monomer percent of aromatic polyester subunits. Linear aromatic polyester synthesis and structures are illustratively detailed in U.S. Pat. No. 3,351,611. In other inventive embodiments, the monomer percent of aromatic polyester subunits is between 50 and 90 percent. In still other inventive embodiments, a linear aromatic polyester is aliphatically saturated. It is appreciated that a linear aromatic polyester operative herein is either amorphous or crystalline. In still other inventive embodiments, the linear aromatic polyester has a glass transition temperature (Tg) of between 60° C. and 120° C., and in still other inventive embodiments, Tg of between 65° C. and 110° C. In still other inventive embodiments, the linear aromatic polyester has a hydroxyl number from 2 to 80 mg/g KOH/g. In still other inventive embodiments, the linear aromatic polyester has a molecular weight of between 9,000 g/mol and 108,000 g/mol.

The resins of the present invention are dissolved or at least dispersed in a solvent. A solvent suitable for dissolution or dispersion of an inventive resin illustratively include halogenated hydrocarbons such as methylene chloride, chloroform, 1,2-dichloroethane, tetrachloroethane, methylchloroform, 1,1,2-trichloroethane; C₃-C₈ ketones, such as methyl ethyl ketone, acetone, and diacetone alcohol; cyclic C₃-C₆ ethers; (C₁-C₄)—O—(C₁-C₄) ethers; ethylene glycol ethers; diethylene glycol ethers; C₂-C₁₄ alkyl esters of C₂-C₈ carboxylic acids, and combinations any of the aforementioned that are miscible. Typically, solvent as a single component or mixture of miscible solvents is exclusive of naphtha and is present from 20 to 40 total weight percent of a complete formulation for application to a substrate. In contrast to prior art marking formulations in which resins constituted the largest single component by weight of a dried formulation as hard resin film containing colorant, according to the present invention, inorganic particulate is present as the largest single component of a hard resin film produced, and in certain inventive embodiments, second only to solvent in a fully solvated formulation prior to drying to a hard resin film. A secondary colorant is present is some inventive embodiments.

Upon dispersion or dissolution of resin in a solvent along with an organic dye, an inventive formulation is placed within a marker tube. The construct of such a tube is conventional to the art. The resin is typically present from 11 to 60 total weight percent of a formulation and in specific inventive embodiments from 18 to 43 total weight percent. It has been found that solvent that is a mixture of ketones or esters such as Aromatic 100, 150, or 200 a provides for a marking that touch dries in less than 60 seconds at standard temperature and pressure.

An organic dye is provided to selectively color a marker formulation according to the present invention. Organic dyes operative herein for formulations with a viscosity of greater than 10,000 centipoise illustratively include cyanine such as phthalocyanine blue or diazahemicyanine; azo dyes such as monoazo, disazo, trisazo, tetrakisazo, polyazo; anthraquinone dyes; polycyclic quinones; azine; benzodifurane; carotenoids; coumarin; diphenylmethane; formazan; naphthalimides; pyrazoles, stilbenes, triarylmethane, triphenylmethane, xanthenes; and derivatized forms of any of the aforementioned in which a nitro, nitrosyl, sulfonyl, hydroxyl, replaces a proton therein; and combinations thereof. It is further appreciated that the aforementioned dyes are amenable to dissolution or suspension in the solvated linear aromatic resin. An organic dye is present from 0.2 to 20 total weight percent of a complete formulation for application to a substrate. It is appreciated that while a dye can be operative in amounts as low as 0.2 total weight percent, particulate pigments require larger quantities to affect coloring. In certain inventive embodiments, the colorant is present from 0.5 to 8 total weight percent. It is appreciated that a colorant package in some embodiments includes solvents, surfactants, non-foaming agents, and other conventional additives to facilitate storage and dispersion. Resort to Solvent Blue 5 dye at any viscosity is able to provide a high purity strong blue color formulation.

In some inventive embodiments, titanium dioxide pigment is present and provides the formulation with marking properties such as durability, gloss, opacity, and undertone.

In order to increase the viscosity of an inventive formulation and otherwise improve the dispensing properties thereof from a marker pen or the quality of resulting markings, a montmorillonite-, kaolin-based thickener, or both are optionally present. Unfortunately, naturally occurring montmorillonite or kaolin-based thickeners of an inventive formulation are routinely too high in extraneous ions and elements excluded by the present invention. Therefore, a synthetic clay may be used as a substitute or is filter-cleaned to within the required limits to have the required purity or the clay is filtered to wash extraneous ions and elements therefrom. A montmorillonite- or kaolin-based thickener is present from 0 to 40 percent by weight. The thickener is present in specific embodiments from 0.5 to 28 total weight percent of a complete formulation for application to a substrate. To the extent a multifunctional alcohol is used as an adjunct with the thickener, the multifunctional alcohol is typically present from 1 to 5 weight percent of the thickener.

Multifunctional alcohols are commonly used to enhance thickener properties that are themselves rheological agents. A rheological agent is present from 0 to 25 percent by weight. The rheological agent is present in specific embodiments from 2 to 20 total weight percent. Rheological agents operative herein illustratively include organically modified castor oil derivatives, partially dimerized rosin, and combinations thereof. To the extent a multifunctional alcohol is used, it is typically present from 1 to 5 weight percent of the thixotropic agent.

A siccative additive is provided in some inventive embodiments to regulate the drying speed of the formulation. A siccative additive operative in the present invention illustratively includes a transition metal carboxylate for which C₆-C₂₄ linear or branched carboxylic acids or various naphthenic acids are used as ligands, and combinations thereof. 2-ethyl hexanoic acid is exemplary of such carboxylates. Transition metals typically include cobalt, zirconium, and manganese; and a routinely used in the printing industry as drying accelerators. A siccative additive is present from 0 to 3 percent of a complete formulation for application to a substrate. In certain inventive embodiments, the siccative additive, if present, is provided from 0.5 to 2 total weight percent. In specific inventive embodiments, a montmorillonite- or kaolin-based thickener is present in an amount sufficient to yield a viscosity of a 3,000 to 40,000 centipoise for a Solvent Blue 5 formulation and from 10,000 to 40,000 for other dyes.

In some inventive formulations, particularly well-suited for application from a tube having an opening, the formulation is adjusted to not only have storage stability of at least 1 month and in some instances more than 3 months without appreciable separation, but also to maintain viscosity within 20% of the as formulated viscosity over this time. The tube selectively sealed with a cap for extruding the formulation as a bead. The bead typically having a width of 3.2±1 millimeters (mm).

A marker pen is used to apply an inventive formulation to a substrate to apply a marking thereto. The marker pen has a barrel and a nose cone connected to the barrel and terminating in a tip, the barrel and nose cone collectively defining a volume. A bladder in some embodiments contains an inventive formulation within the volume.

The formulation is readily supplied in a marking tube. The marking tube is typically formed of aluminum and includes an opening to define a volume for containing the formulation. To preclude the formulation drying prematurely on the opening, a cap is selectively removable to expose the opening from which the formulation is dispensed as a bead. In this way, a controlled bead width is easily applied to a surface.

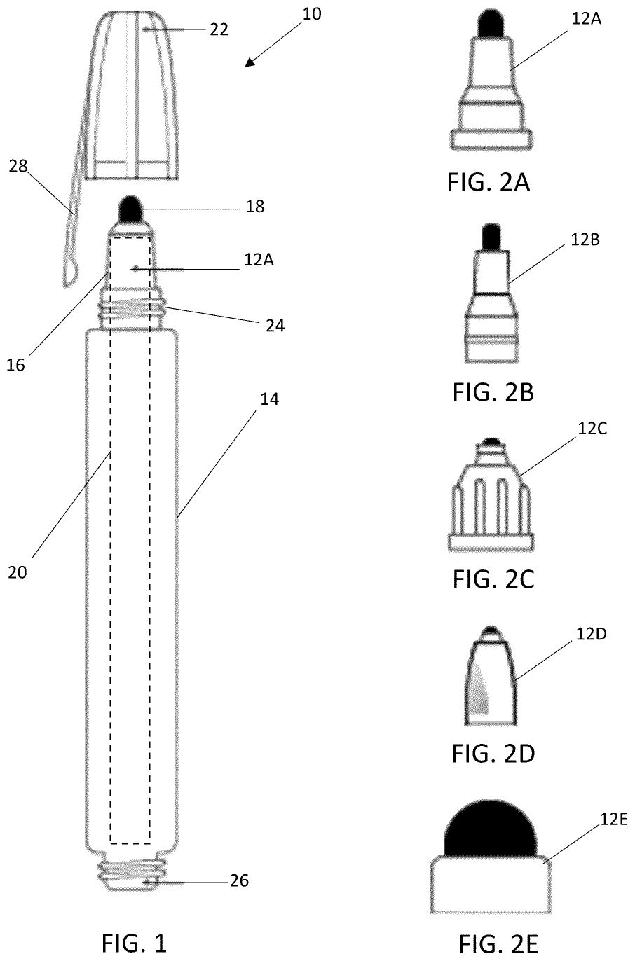

Referring now to the figures, FIG. 1 is a side view of a marker 10 with a medium acrylic nib fiber tip 12A with valve action. The marker pen 10 has a barrel 14 and a nose cone 16 connected to the barrel 14 and terminating in a tip 18, the barrel 14 and nose cone 16 collectively defining a volume. It is appreciated that the nose cone 16 and tip 18 form the nib. A bladder 20 (shown in dashed line) with inventive formulation as disclosed herein may be held in the volume. A cap 22 is selectively removable to the proximal portion of the barrel 14 with cap threads 24. It is appreciated that the cap 22 may alternatively have an interference snap-on fit that secures the cap 22 to the barrel 14. The distal end of the barrel may have barrel threads 26 that allows the threaded cap to be secured when removed from the proximal portion of the barrel 14. The barrel threads 26 may also be used to secure the marker to a jig or apparatus, illustratively including a manufacturing or inspection robots. A pocket clip 28 may be affixed to the cap 22, which besides convenience also acts to prevent the marker 10 from rolling on surfaces when the marker 10 is not in use.

FIGS. 2A-2E are a series of detailed views of a medium nib 12A, fine nib 12B, steel tip 12C, steel fine tip 12D, and pressure bulb 12E, respectively for use with embodiments of the marker 10 of FIG. 1. The medium nib 12A may be an acrylic nib fiber tip with valve-action. The fine nib 12B may be an acrylic nib fiber tip with valve-action. The steel tip 12C may have a roller ball tip that makes 2.4 mm ( 3/32′) wide marks. The steel fine tip 12D may have a roller ball tip that makes 1.2 mm ( 3/64′) wide marks. Pressure bulb 12E is located at the end of steel tip markers for controlled ink flow.

An inventive formulation is summarized in the following Table 1.

TABLE 1
Inventive surface marker formulation in typical and specific
versions, with amount as total weight percent.

| | Typical | Specific |
|---|---|---|
| Ingredient | Amount (%) | Amount (%) |
| Resin | 16-37 | 20-35 |
| Organic dye(s) | 0.2-20 | 0.5-8 |
| Montmorillonite- or | 0-40 | 0.5-28 |
| kaolin-based thickener | | |
| TiO₂ pigment | 0-25 | 5-20 |
| Rheological agent | 0-25 | 2-20 |
| Siccative additive | 0-3 | 0-2 |
| Solvent | remainder | remainder |

The present invention is further illustrated with respect to the following non-limiting examples:

### Example 1

A white marker formulation for a high purity surface marker formulation is summarized in Table 2. In which extraneous ions and metals are limited to a chloride content of less than 100 ppm, a total metal content of less than 300 ppm, and a sulfur content of less than 250 ppm.

TABLE 2
A white marker formulation with component amounts shown
as weight percentage of the total weight percent.

| | Weight |
|---|---|
| Component | % |
| 2-butanone oxime | 3.06 |
| Soya Lecithin | 0.49 |
| Purified kaolin | 24.62 |
| clay <44 micron | |
| Rheological agent | 1.48 |
| (castor oil based) | |
| Titanium dioxide | 17.34 |
| white pigment | |
| Oil-modified | 53.01 |
| aromatic | |
| polyurethane resin | |

The resulting formulation is packed into in an aluminum tube and crimped using a conventional tube filling system and applied as a bead 3.2 millimeters (mm) in width and a thickness of 0.5 mm onto substrate panels of glass, mild steel, aluminum, ceramic, porcelain, acrylic, polyethylene, and polyamide without exhibiting sagging. The formulation dried in less than 60 seconds to the touch with the volatilization of the solvent.

### Examples 2-6

High purity surface marker formulations for different colors are summarized in Table 3. In which extraneous ions and metals are limited to a chloride content of less than 100 ppm, a total metal content of less than 300 ppm, and a sulfur content of less than 250 ppm.

TABLE 3
Inventive surface marker formulations by color in total
weight percent with note of the viscosity thereof.

| | Component | | | | |
|---|---|---|---|---|---|
| | Ex. 2 | Ex. 3 | Ex. 4 | Ex. 5 | Ex. 6 |
| | Color | | | | |
| | White | Yellow | Black | Red | Blue |
| Diacetone Alcohol | | | 59.30 | | |
| Soya Lecithin | 0.50 | 0.50 | | 0.50 | 0.50 |
| Oil Scarlet 308 | | | | 5.00 | |
| (CAS 6483-64-3) | | | | | |
| Benzenamine, reaction | | | 7.50 | | |
| products with aniline | | | | | |
| hydrochloride and | | | | | |
| nitrobenzene | | | | | |
| (CAS 101357-15-7) | | | | | |
| 4-(Diethylamino)azobenzene | | 3.85 | | | |
| Solvent Blue 5 & Organic | | | | | 5.00 |
| Acid (CAS 1325-86-6) | | | | | |
| Rheological agent (castor | 1.00 | 1.00 | | | 0.90 |
| oil based) | | | | | |
| Titanium dioxide white | 43.00 | 39.00 | | 40.00 | 40.00 |
| pigment | | | | | |
| Rheological agent (Partially | 17.00 | 17.00 | 7.50 | 16.50 | 16.50 |
| Dimerized Rosin) | | | | | |
| Propylene Glycol (Mono) | | | 25.70 | | |
| Methyl Ether | | | | | |
| Aromatic 100 | 38.50 | 38.65 | | 38.00 | 37.10 |
| Thickener (purified | 0.99 | 0.95 | 0.99 | 0.99 | |
| bentonite clay) | | | | | |
| Viscosity (cP) | 20-35 | 20-35 | 20-35 | 20-35 | 20-35 |
| of which VOC % is: | 39.00 | 39.15 | 85.00 | 39.64 | 37.60 |

The formulation of each of Examples 2-6 is applied to panels and tested per Example 1 with like results. The colors of Examples 2-6 are noted as perceived by a normal human eye.

### Example 7

The composition of Example 6 has little to no halogen impurities as commercially available and is devoid of copper and the formulation has a brilliant, strong blue color.

The formulation of Example 6 is compared with two conventional blue high purity inks formulations. A first comparative example contains a copper complex dye, and this does not fully meet the requirements of the specifications. A second comparative example also contains a copper complex dye, but in lower quantity as a total percentage, yet is noted to be baby-blue (light blue) in color rather than a strong blue.

As a person skilled in the art will recognize from the previous detailed description and from the figures and claims, modifications and changes can be made to the preferred embodiments of the invention without departing from the scope of this invention defined in the following claims.

1. A marker pen comprising:
a barrel;
a nose cone connected to the barrel and terminating in a tip, the barrel and nose cone collectively defining a volume;
a marker formulation contained within the volume and comprising:
a resin;
a solvent in which said resin is dissolved or dispersed;
an organic dye of Solvent Blue 5;
with the proviso that the formulation has a chloride content of less than 100 ppm, a total metal content of less than 300 ppm, and a sulfur content of less than 250 ppm.

2. The marker pen of claim 1 further comprising a bladder within the volume, the formulation within the bladder.

3. The marker pen of claim 1 wherein the tip a steel roller ball or a porous polymeric nib.

4. The marker pen of claim 1 wherein said solvent is a majority by solvent weight percentage C₃-C₈ ketones.

5. The formulation of claim 1 wherein said thickener is present in an amount sufficient to yield a viscosity of a 3,000 to 12,000 centipoise for the formulation.

6. The formulation of claim 1 further comprising at least one additive of: a siccative, an anti-skinning agent, and a wetting agent.

7. The marker pen of claim 1 wherein the Solvent Blue 5 is present in an amount of 1 to 10 total weight percent and the color is strong blue.

8. A marker pen comprising:
a barrel;
a nose cone connected to the barrel and terminating in a tip, the barrel and nose cone collectively defining a volume;
a marker formulation contained within the volume and comprising:
a resin;
a solvent in which said resin is dissolved or dispersed;
an organic dye; and
a thickener;
with the proviso that the formulation has a viscosity of at least 10,000 centipoise, chloride content of less than 450 ppm, a total metal content of less than 200 ppm, and a sulfur content of less than 630 ppm.

9. The marker pen of claim 8 further comprising titanium dioxide and the is present.

10. The marker pen of claim 8 wherein the organic dye is a red, blue, or yellow as perceived by a normal human eye.

11. The marker pen of claim 8 further comprising a rheological additive.

12. The marker pen of claim 11 wherein the rheological additive is a modified castor oil.

13. The marker pen of claim 8 further comprising a kaolin-based thickener, a montmorillonite-based thickener, or a combination thereof.

14. The marker pen of claim 13 wherein the montmorillonite-based thickener alone is present.

15. The marker pen of claim 13 wherein the kaolin-based thickener alone is present.

16. The marker pen of claim 8 wherein the organic dye is Solvent Blue 5.

17. The marker pen of claim 16 wherein Solvent Blue 5 is present in an amount of 1 to 10 total weight percent and the color is strong blue.

18. A process of marking a surface comprising:
applying the formulation of claim 8 from the marker pen to a surface as a continuous bead; and
drying the formulation to a state of dry-to-touch to mark the surface.

19. The process of claim 18 wherein said applying of the formulation is as a bead having a width of 3.2±1 millimeters.

20. The process of claim 18 wherein said drying occurs to full hardness in 24 hours under standard temperature and pressure.
